(19) United States
(12) Patent Application Publication
(10) Pub. No.: US 2013/0227356 A1
(43) Pub. Date: Aug. 29, 2013

(54) APPARATUS AND METHOD FOR HANDLING REBOOTING OF MOBILE TERMINAL

(71) Applicant: PANTECH CO., LTD., (US)

(72) Inventors: Tae-Joong KIM, Seoul (KR); Seung-Hwa JI, Seoul (KR)

(73) Assignee: PANTECH CO., LTD., Seoul PANTECH CO., LTD. (KR)

(21) Appl. No.: 13/652,862

(22) Filed: Oct. 16, 2012

(30) Foreign Application Priority Data
Feb. 29, 2012 (KR) 10-2012-0021401

(51) Int. Cl. G06F 11/14

(52) U.S. Cl. 714/48; 714/E11.142

(57) ABSTRACT

A mobile terminal to handle a booting process includes a processor to process the booting process, a log storage to store error information of a module extracted from a system log, and a log comparator, during the booting process, to extract the error information of the module from the log storage, and to exclude an initialization of the module based on the error information of the module stored in the log storage. A method that uses a processor to handle a booting process includes loading error information of a module from a system log to a log storage, processing, using the processor, the booting process by initializing multiple modules, and determining whether to initialize the module based on the loaded error information of the module.

### CROSS-REFERENCE TO RELATED APPLICATION

This application claims priority from and the benefit under 35 U.S.C. §119(a) of a Korean Patent Application No. 10-2012-0021401, filed on Feb. 29, 2012, which is incorporated herein by reference for all purposes as if fully set forth herein.

### BACKGROUND

1. Field

The following description relates to a configuration of a mobile terminal, and more particularly, to an apparatus and method for handling a reboot process of resetting an operating system (OS) in response to a booting problem occurred in a mobile terminal.

2. Discussion of the Background

With the development of information technology (IT), types of electronic devices are diversified. The diversification trend may be more noticeable in a mobile terminal industry than that of a fixed-type electronic device industry, such as desktop computer industry. For example, a cellular phone, an MP3 player, a digital camera, a portable multimedia player (PMP), a navigation system, a portable game console, an electronic dictionary, an E-book reader, and a digital multimedia broadcasting (DBM) receiver are being widely used. Furthermore, a tablet computer and a smart pad are rapidly gaining popularity.

A smart mobile terminal, such as a smart phone or a tablet computer, is equipped with a mobile operating system (OS). Examples of the mobile OS include Android™, iPhone OS (iOS®), Windows® Mobile (WM), and the like. Further, rapid improvement in hardware performance of a mobile terminal enables mobile OSs to support multitasking and background processing. For the above multitasking and background processing operations, various hardware devices, such as a display, a camera, a local area communication device (for example, Bluetooth®), a high capacity memory, a sensor, a universal serial bus (USB), a keypad, a wireless local area network (WLAN), audio, and the like, may be provided in the mobile terminal. Device drivers, which are software programs to support the above devices, are also installed in the mobile terminal.

As described above, the number of hardware devices and software programs that are provided and installed in the mobile terminal is increasing, and multitasking processes run in the developed mobile terminal are more complex. Accordingly, due to the occurrence of system failures in the mobile terminal and the like, an OS may more frequently fall into a deadlock state (for example, a kernel panic, a deadlock or hang). The deadlock state commonly indicates that a system of the mobile terminal cannot boot properly during a system booting operation, or that an OS operation is suspended temporally or for a long period of time due to a problem occurred in a device or driver installed in the mobile terminal while a kernel or an application is operating. In general, a system reboot process may be performed to recover the mobile terminal from the deadlock state.

If the OS falls into the deadlock state, rerouting to a predetermined address may be performed. At the predetermined address, problems that have occurred in the system may be handled. At the predetermined address, a problem of the system may be initially handled and a state of a central processing unit (CPU) and log may be displayed on a console device. The log may be stored in a rewrite (RW) area of a read only memory (ROM) in which OS software is stored. If the handling of the problem is completed, a system reboot process may be performed.

According to the above reboot handling method, generated log information (for example, a bug report) may be stored in a storage, such as ROM, but the log information is not generally used during the reboot process. Accordingly, when the system is rebooted, the system may be unaware that the system was previously in a deadlock state. If a problem that caused the system to fall into the deadlock state is excluded or resolved, the system may operate normally by rebooting. However, when the problem is not remedied, the system may operate abnormally even though a rebooting is attempted. Since the rebooting process may not cure the problem, it may be possible for the system to fall into the deadlock state again. In this case, even if a problem occurs in non-essential devices installed in the mobile terminal, a user may not be able to use the mobile terminal, and may not be able to back-up important information stored in the mobile terminal.

### SUMMARY

The following description relates to an apparatus and method for handling rebooting of a mobile terminal that may smoothly perform rebooting if a mobile terminal falls into a deadlock state.

The following description also relates to an apparatus and method for handling rebooting of a mobile terminal that may effectively verify a cause of a deadlock state and process rebooting to avoid the problem.

Additional features of the invention will be set forth in the description which follows, and in part will be apparent from the description, or may be learned by practice of the invention.

Exemplary embodiments of the present invention provide a mobile terminal to handle a booting process including a processor to process the booting process, a log storage to store error information of a module extracted from a system log, and a log comparator, during the booting process, to extract the error information of the module from the log storage, and to exclude an initialization of the module based on the error information of the module stored in the log storage.

Exemplary embodiments of the present invention provide a method that uses a processor to handle a booting process including loading error information of a module from a system log to a log storage, processing, using the processor, the booting process by initializing multiple modules, and determining whether to initialize the module based on the loaded error information of the module.

Exemplary embodiments of the present invention provide a mobile terminal to handle a booting process including a processor to process the booting process, a log analyzer to read a log table including identification information of a module and a flag of the module, and to modify a system log by writing the identification information of the module in the system log if the flag of the module indicates that the module is in a deadlock state, and a log storage to store the identification information of the module extracted from a system log.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a configuration of an apparatus to handle rebooting of a mobile terminal according to an exemplary embodiment of the present invention.

FIG. 2 is a schematic diagram illustrating a process of transmitting, from a device driver to a driver observer, a driver signal including state information according to an exemplary embodiment of the present invention.

FIG. 3 is a flowchart illustrating a method for handling rebooting of a mobile terminal according to an exemplary embodiment of the present invention.

FIG. 4 is a flowchart illustrating a method for handling rebooting of a mobile terminal according to an exemplary embodiment of the present invention.

FIG. 5 is a flowchart illustrating a method for handling rebooting of a mobile terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

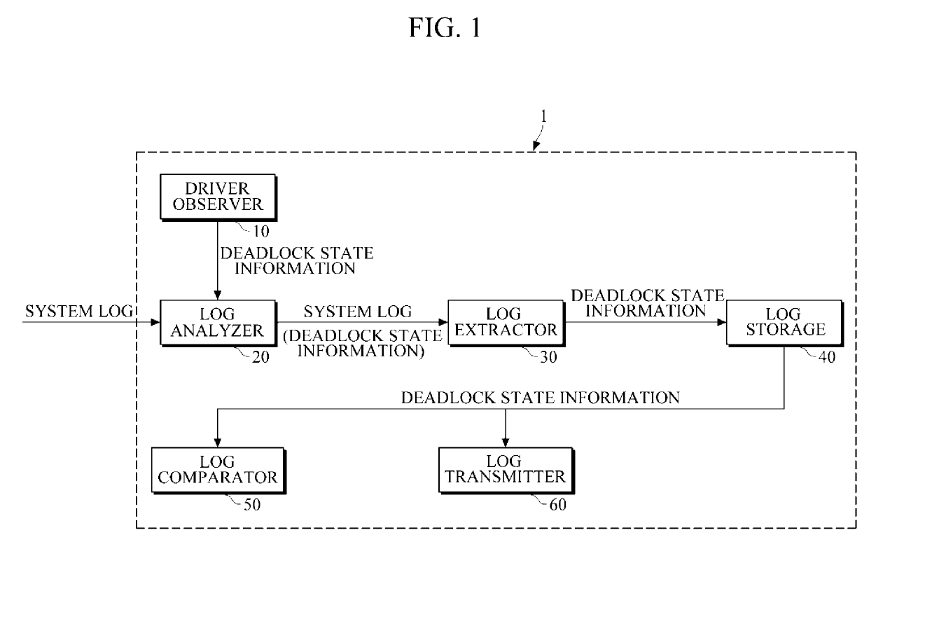

FIG. 1 shows a configuration of an apparatus to handle rebooting of a mobile terminal according to an exemplary embodiment of the present invention. Referring to FIG. 1, a reboot handling apparatus 1 includes a driver observer 10, a log analyzer 20, a log extractor 30, a log storage 40, and a log comparator 50. The reboot handling apparatus 1 may further include a log transmitter 60. The driver observer 10, the log analyzer 20, the log extractor 30, the log storage 40, the log comparator 50, and the log transmitter 60 of the reboot handling apparatus 1 are logically divided and illustrated based on respective operations of the driver observer 10, the log analyzer 20, the log extractor 30, the log storage 40, the log comparator 50, and the log transmitter 60. Therefore, at least two elements may be integrated into one hardware component or software module, or one element may be implemented by multiple hardware components (e.g., processors) or software modules.

The reboot handling apparatus 1 may be an apparatus to manage a system of a mobile terminal to be rebooted and manage the operating system of the mobile terminal to be operated normally if the mobile terminal falls into a deadlock state or has an operation error. A problem that triggers a state in which the mobile terminal operates abnormally may include a problem of a device driver installed in the mobile terminal that causes the system to fall into the deadlock state, a hang state, a kernel panic state, and the like. Hereinafter, the state in which the mobile terminal operates abnormal may be referred to as the deadlock state. Error information may be generated by the reboot handling apparatus 1 if the kernel panic, a deadlock, a hang, or the like occurs. The error information may include kernel panic information, deadlock state information, and hang state information, etc. Hereinafter, the error information may be referred to as the deadlock state information. The reboot handling apparatus 1 may handle a reboot process if a problem occurs to cause the mobile terminal to fall into the deadlock state from a normal operation. Further, the reboot handling apparatus 1 may also handle a reboot process if a problem occurs to cause the mobile terminal to fall into the deadlock state during a booting process.

The driver observer 10 may detect a module, such as a device driver that causes the mobile terminal to fall into the deadlock state, and may transfer deadlock state information to the log analyzer 20. The “deadlock state information” may indicate the cause of the deadlock state of the mobile terminal, and may include device driver identification (ID) information indicating the device driver that causes the deadlock state. If the mobile terminal falls into the deadlock state, the driver observer 10 may verify a module (for example, a device driver) that is initialized abnormally or operates abnormally, and may transfer ID information (for example, the name of the device driver) of the corresponding module to the log analyzer 20. The deadlock state information may include count information that corresponds to the number of times that the corresponding device driver has caused the problem. The driver observer 10 may also transfer the count information to the log analyzer 20 along with the ID information of the device driver. Modules initialized during a booting process may include device drivers, such as a display driver, a camera driver, a Bluetooth® driver, a shared memory driver, a sensor driver, a Universal Serial Bus (USB) driver, a keypad driver, a Wi-Fi driver, an audio driver, and the like.

For the above operation, during a system booting process, the driver observer 10 may detect a problematic device driver by checking whether each device driver initialized normally. Further, the driver observer 10 may detect the problematic device driver by receiving a driver signal including state information from each device driver while the system is operating normally.

Hereinafter, a process of detecting, by the driver observer 10, information about a device driver that has triggered a problem while booting the mobile terminal will be described. During the booting of the mobile terminal, a setting of an OS may be performed so that the mobile terminal may operate normally, and a kernel panic may occur while initializing a kernel driver. Throughout the specification, Android™ OS may be employed as the OS for description purposes, but aspects of the present invention are not limited as such. Different types of OS, such as iOS®, Windows® Mobile, and the like, may be used as well.

If the system of the mobile terminal is booted, a kernel image is loaded from a ROM to a random access memory (RAM) and then a kernel initializes device drivers installed in the mobile terminal. The kernel_init( ) function is a function of performing an initialization process. The kernel_init( ) function includes a role to call a function called do_one_initcall( ). The do_one_initcall( ) function is a function of initializing modules to be loaded by the kernel. An initialization process of each module is performed by repeatedly calling, by the kernel_init( ) function, the do_one_initcall( ) function according to a predetermined order. If the system of the mobile terminal falls into a deadlock state during a booting process, the driver observer 10 may verify that a problem has occurred in a module (device driver) corresponding to a checking order directly preceding to a checking order in which the do_one_inicall( ) function is not called normally.

Further, a module of which initialization is performed abnormally may be indicated using an indication method. Since a statically registered device driver may remain registered to the mobile terminal without a detachment, the checking order may not be changed during the initialization of the device driver. To utilize the above aspect, a log table (for example, a device driver initialization success/failure table) in which the device driver is listed in the same order as initialization order of the device drivers may be generated, and the table may include a flag indicating whether the device driver initialized normally with respect to each item of the list. For example, a flag value may be set as a positive value if the device driver initialized normally, and the flag value may be set as zero or a negative value if the device driver initialized abnormally. With reference to the generated table, the driver observer 10 may verify a device driver that initialized normally and a device driver that initialized abnormally during the booting process. The log table may be stored in the ROM and may be loaded on a specific region of the RAM during the booting process. If a flag of a device driver has a negative value, error information of the device driver (e.g., deadlock state information of the device driver) may be written in a system log. For example, the error information including ID information of device drivers having negative flag values may be recorded in a system log. The error information may further include count information of the device drivers having negative flag values, and the system log may be stored in a rewritable area of a ROM. Further, during a booting process, the error information may be retrieved from the rewritable area of the ROM and be loaded into a shared memory in a random access memory (RAM) after initializing the shared memory in the RAM. Further, the error information may be temporarily stored in a register (e.g., register R4 of ARM core). The error information stored in the register R4 or stored in the RAM may be retrieved and be compared with information of a device driver for initialization. If the compared values are matched, the log comparator 50 may determine the device driver for initialization is in a deadlock state and check next module for initialization. Thus, the device driver determined to be in a deadlock state may be skipped from initialization.

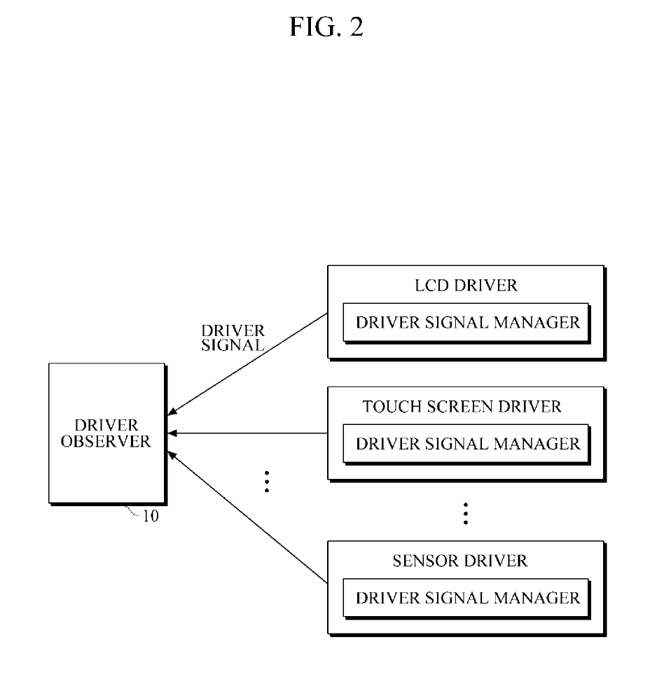

Next, a process of verifying, by the driver observer 10, information about a problematic device driver that causes a problem while the mobile terminal is operating normally will be described with reference to FIG. 2. FIG. 2 is a schematic diagram illustrating a process of transmitting, from a device driver installed in a mobile terminal to a driver observer, a driver signal including state information according to an exemplary embodiment of the present invention.

Referring to FIG. 2, drivers, for example, a liquid crystal display (LCD) driver, a touch screen driver, a sensor driver, and the like, which are installed in a kernel end of the mobile terminal and operate normally, may transmit a driver signal to the driver observer 10. The driver signal may be a signal indicating whether a corresponding device driver is operating normally. For the above operation, a driver signal manager may be installed in each device driver. The driver signal manager of each device driver may sequentially transmit a driver signal to the driver observer 10. If the driver observer 10 does not receive a driver signal from a specific device driver or receives a driver signal indicating that the specific device driver is operating abnormally, the device observer 10 may determine that a problem has occurred in the corresponding device driver.

Normally operating drivers installed in the mobile terminal may generate and transmit a driver signal. The driver observer 10 may receive and process signals of the drivers that are installed normally. For example, the driver observer 10 may store names (for example, as described above, a table in which driver names are listed as items) of the drivers installed in the mobile terminal. The drivers may periodically transmit a driver signal to the driver observer 10.

For transmission of a driver signal, the driver signal manager may be installed in each driver or the driver signal manager may manage signal transmissions of multiple drivers. When normally entering and operating in a device driver of a kernel in response to a request from an application, functions of the corresponding device driver may be reported to the driver signal manager that there is no problem. The driver signal manager transmits, to the driver observer 10, a driver signal indicating that there is no problem in the corresponding device driver, and the driver observer 10 receiving the driver signal may indicate with a flag that the corresponding device driver is operating in normal status.

When entering the device driver of the kernel in response to a request from the application and a problem occurs, the following operations may be performed. A function for operation of the device driver may transfer, to the driver signal manager, a signal indicating the entry into the corresponding function and execute the corresponding function. When falling into a deadlock state while executing the function, that is, when a deadlock or hang occurs while executing the function, the function is not executed in the device driver anymore. The driver signal manager may wait until the function is terminated. If the function is executed abnormally and thereby not terminated even after a predetermined period of time has lapsed, or if a signal indicating that the corresponding function is terminated is not transferred within the predetermined period of time, the driver signal manager may transmit, to the driver observer 10, a driver signal indicating that the corresponding device driver has a problem. The driver observer 10 receiving the driver signal may indicate an abnormal status of the device driver with a flag that the corresponding device driver is operating abnormally.

Referring back to FIG. 1, the log analyzer 20 may analyze a system log generated when a problem occurs in the system of the mobile terminal and may add the deadlock state information received from the driver observer 10 to the system log. For example, the log analyzer 20 may analyze a table including deadlock state information received from the driver observer 10 and thereby verify driver ID information (for example, a device driver name, such as lcd_ortus, and the like) indicating a device driver in which a problem has occurred, and may include the verified driver ID information in the system log. The log analyzer 20 may also add count information indicating the number of times that the problem has occurred in the corresponding device driver to the system log. Thus, the system log may be modified into a modified system log to include the deadlock state information and/or the count information.

The log extractor 30 may extract, from the system log, the deadlock state information included by the log analyzer 20, for example, the driver ID information. If the count information is included in the deadlock state information or the system log, the log extractor 30 may also extract the count information from the system log if the count information is included in the system log or the deadlock state information. If the log analyzer 20 includes the driver ID information in a predetermined position of the system log, the log extractor 30 may retrieve a string corresponding to the driver ID information and/or the count information by opening a corresponding system log file.

The log storage 40 may store the deadlock state information, for example, the driver ID information extracted by the log extractor 30. If the count information is included in the deadlock state information, the log storage 40 may also store the count information and/or a log table. The deadlock state information extracted by the log extractor 30 may be stored in a determined area (RW area) of ROM in which a system booting file is stored. The deadlock state information may be stored in the RW area in order to use the deadlock state information together with other booting information while the system of the mobile terminal is booted. If the system of the mobile terminal is booted, a shared memory of RAM is initialized and booting information stored in the RW area of ROM is loaded into the shared memory. In the booting process, the deadlock state information may also be loaded into the shared memory.

The log comparator 50 may compare the deadlock state information, for example, the driver ID information stored in the determined area of ROM, with a device driver to be initialized in rebooting, and may manage rebooting to be performed in a state where the device driver that caused the deadlock state is excluded based on the comparison result (the device driver is in inactive state). If the count information is stored in an area of ROM, the log comparator 50 may also control the reboot process using the count information. More specifically, the log comparator 50 may enable rebooting to be performed in a state where a device driver corresponding to the driver ID information included in the deadlock state information is excluded (that is, the corresponding device driver is not initialized and thus, is in an inactive state). Further, if the device driver corresponding to the driver ID information and the count information is included and greater than or equal to a reference value, the log comparator 50 may enable the rebooting to be performed in a state where the corresponding device driver is excluded. Hereinafter, more detailed description will be provided.

If the system is rebooted, a kernel is booted and a device driver is initialized. For example, in Android™ OS, functions registered by module_init may be initialized while a do_initcalls function is executed. Device drivers of the kernel have their own unique names. A system that statically registers a device driver registers a device before the driver is initialized (in the case of Android™ OS, registered to a sysFS file system). Then, sysFS compares a driver name with a device name used when the driver is registered. If the device name matches with the driver name, a predetermined function (a probe function of the driver) registered to the driver is executed and the device driver is initialized. If the device name does not match with the driver name, the predetermined function is not executed and the device driver is not initialized.

As described above, if the system is rebooted, the kernel is loaded. If the device driver is registered, the log comparator 50 verifies whether deadlock state information is stored. If the deadlock state information is not stored, or if the deadlock state information is stored but the count number (count information) is less than a reference value, the system is booted based on a normal booting sequence in which initialization is performed with respect to all the included drivers according to an existing method. If the deadlock state information is stored (or if the deadlock state information and the count information is stored and the count information of the corresponding device driver is greater than or equal to a reference value), the log comparator 50 may manage an initialization process not to be performed with respect to the device driver included in the deadlock state information.

For example, if a problem occurs while a kernel end is initializing a device driver that causes the system of the mobile terminal to reboot, deadlock state information stored in a determined area of ROM may be loaded into the shared memory of RAM together with other booting information. When the system of the mobile terminal is rebooted, information required for booting are already loaded into the shared memory. By accessing the shared memory in advance before initializing the device driver, it may be possible to obtain information about the problematic device driver. If the obtained information matches with a name of a device driver included in the deadlock state information by sequentially comparing the obtained information with a device driver being initialized, initialization may not be performed with respect to the device driver that matches with the obtained information.

Referring to FIG. 1, the log transmitter 60 may transmit, to a server operated by a manufacturer, deadlock state information stored in the log storage 40 and/or the system log including the deadlock state information. If the system of the mobile terminal is booted normally, a user may access the server over a communication network, e.g., a mobile communication network or a WLAN, and may transmit a problem to a manufacturer's server of the mobile terminal. The manufacturer's server may verify the problem and transmit, to the mobile terminal, software or a patch file to resolve the problem. If the problem analyzed by the manufacturer's server indicates that the problem relates to a hardware problem, the manufacturer's server may also provide the user with information indicating that the user needs to go to a service center (CS) nearby to resolve the problem.

As described above, if a system falls into a deadlock state due to a problem of a device driver, the system may be rebooted without initializing the device driver in a state where the corresponding device driver is in an inactive state. The system may be rebooted without initializing the device driver in which the problem has occurred at least once, or, if the count information is utilized and included, the system may be rebooted without initializing the device driver in which the problem has occurred a number of times greater than equal to a reference value (when count information is greater than or equal to the reference value). If the same problem occurs several times in the mobile terminal, causing the mobile terminal to be reset several times or to fail the reboot, it may be possible to analyze the cause and boot the mobile terminal without initializing a device driver that is determined to be operating abnormally or without executing a problematic function. Even though the device driver in which the problem has occurred is not repaired, the user may back-up important information stored in the mobile terminal by booting the system of the mobile terminal without initializing a problematic device driver. The user may transmit the problem to the manufacturer's server, thereby enabling the manufacturer to efficiently and quickly resolve the problem of the mobile terminal.

Further, information transmitted from the log transmitter 60 to the manufacturer's server may be displayed on a display of the mobile terminal. The information displayed on the display of the mobile terminal may be used to inform the user about a device driver in which a problem has occurred while the mobile terminal is being booted or while the mobile terminal is operating normally. By providing the information to the user, the user may remove the problematic device driver or may change the setting of the problematic device driver.

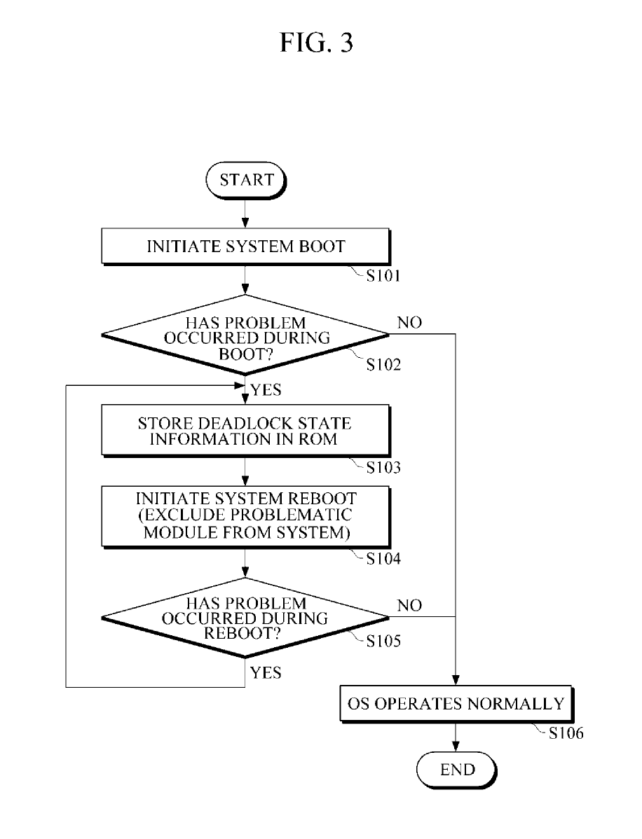

FIG. 3 is a flowchart illustrating a method for handling rebooting of a mobile terminal according to an exemplary embodiment of the present invention. While booting a system of the mobile terminal, a device driver may be initialized abnormally and a problem of the device driver may cause the mobile terminal to fall into a deadlock state. If the count information is not utilized and not included, the number of times that the problem has occurred in the device driver may not be considered in rebooting.

Referring to FIG. 3, a booting process of a system of a mobile terminal is initiated in operation S101. As described above with reference to FIG. 1 and FIG. 2, the system booting process of the mobile terminal may include a process of loading, into a shared memory of RAM, booting information stored in a determined area (for example, a RW area) of ROM. During the booting process, it may be determined whether a problem has occurred in operation S102. If it is determined that a problem has not occurred during the booting process as determined in operation S102, an OS is set and operates normally in operation S106), and thus a reboot process is not performed.

If it is determined that a problem has occurred during the booting process, deadlock state information may be stored in the rewrite (RW) area of ROM in operation S103. As described above with reference to FIG. 1 and FIG. 2, the deadlock state information may be generated by the driver observer 10 (see FIG. 1). At least the name of a device driver in which the problem has occurred may be included in the deadlock state information. The number of times (count information) that the problem has occurred may also be included in the deadlock state information. In the description with respect to FIG. 3, the count information is not used to determine whether to perform rebooting, however the operation S105 may be changed to determine whether the problem has occurred a number of times greater than or equal to the reference value. For example, a device driver may be included in the reboot operation until the count information is equal to or greater than a reference value similar to as described below. Information generated by the driver observer 10 may be stored in the rewrite (RW) area of ROM by the log storage 40 (see FIG. 1).

Since system booting of the mobile terminal is not performed appropriately as determined in operation S102, rebooting of the system of the mobile terminal is performed in operation S104. The reboot process of the system of the mobile terminal may be performed by, for example, a reset handler installed within the mobile terminal. The reset handler refers to an apparatus that drives the mobile terminal so that the OS of the mobile terminal may be reset normally by powering off and then powering on the mobile terminal when the OS of the mobile terminal is set abnormally or operates abnormally, or the user resets the mobile terminal. When rebooting the system of the mobile terminal, the deadlock state information stored in operation S103 may also be loaded into a shared memory of RAM together with other booting information. During the rebooting process, the log comparator 50 (see FIG. 1) enables booting to be performed without the device driver included in the deadlock state information. For example, the log comparator 50 (see FIG. 1) may not initialize a device driver having the same name as the device driver included in the deadlock state information, thereby enabling booting to be performed without initializing the problematic device driver.

Further, it may be determined whether a problem has occurred during the reboot process in operation S105. The operation S105 may have the same operation performed in operation S102. If it is determined that a problem has occurred again during the reboot process, the operations S103, S104, and S105 are repeated. If it is determined that a problem has not occurred during the reboot process as determined in operation S105, the OS is set and operates normally. The device driver included in the deadlock state information may not be initialized and thus enters into an inactive state.

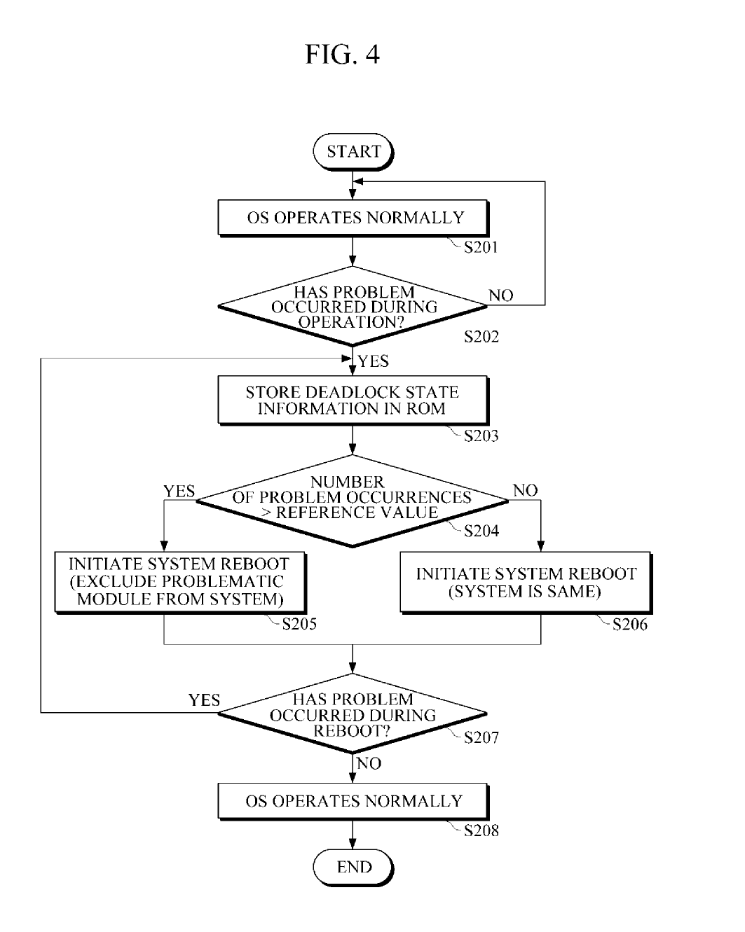

FIG. 4 is a flowchart illustrating a method for handling rebooting of a mobile terminal according to an exemplary embodiment of the present invention. Referring to FIG. 4, a system of a mobile terminal may fall into a deadlock state due to a problem occurred in a device driver while the mobile terminal is operating normally. In this case, the number of times that the problem has occurred in the device driver is considered in rebooting. However, if the count information is not utilized and not included in the system log, the number of times that the problem has occurred is not considered as described above with reference to FIG. 3 or new count information may be added to the system log.

Referring to FIG. 4, an OS of a mobile terminal is operating normally according to a general procedure in operation S201. It may be determined whether a problem has occurred during the normal operation in operation S202. For example, the device observer 10 (see FIG. 1) may check whether a problem has occurred to a device driver based on a driver signal received from the device driver. A driver signal may be periodically received from each device driver. If it is determined that a problem has not occurred as determined in operation 202, the OS is set and operates normally in operation S201) and thus a reboot process is not performed.

If it is determined that a problem has occurred while operating, deadlock state information may be stored in a rewrite (RW) area of ROM in operation S203. As described above with reference to FIG. 1 and FIG. 2, the deadlock state information may be generated by the driver observer 10 (see FIG. 1). The name of the device driver in which the problem has occurred, and count information indicating the number of times that the problem has occurred may be included in the deadlock state information. As described above, information generated by the driver observer 10 may be stored in the rewrite (RW) area of ROM by the log storage 40 (see FIG. 1).

Next, it may be determined whether the number of times that the problem has occurred is greater than or equal to a reference value in operation S204. If the number of times that the problem has occurred in a device driver is less than the reference value, the system of the mobile terminal may be rebooted by a normal rebooting process in operation S206. That is, an initialization process with respect to all of the included device drivers may be performed during the normal rebooting process instead of removing the problematic device driver during the normal rebooting process. If the number of times that the problem has occurred in a device driver is greater than or equal to the reference value, a limited rebooting process may be performed without initializing the problematic device driver in operation S205. That is, during the limited rebooting process, the deadlock state information stored in operation S203 may also be loaded into a shared memory of RAM together with other booting information. In the limited rebooting process, the log comparator 50 (see FIG. 1) may manage the booting to be performed without initializing the device driver included in the deadlock state information.

Further, it may be determined whether a problem has occurred during the reboot process is determined in operation S207. The operation S207 may be performed using the same method as used in the operation S202. If it is determined that the problem has also occurred during the reboot process, the process repeats the operation S203 and subsequent operations. If it is determined that a problem has not occurred during the reboot process, the OS is set and operates normally in operation S208. The device driver included in the deadlock state information is not initialized and enters into an inactive state.

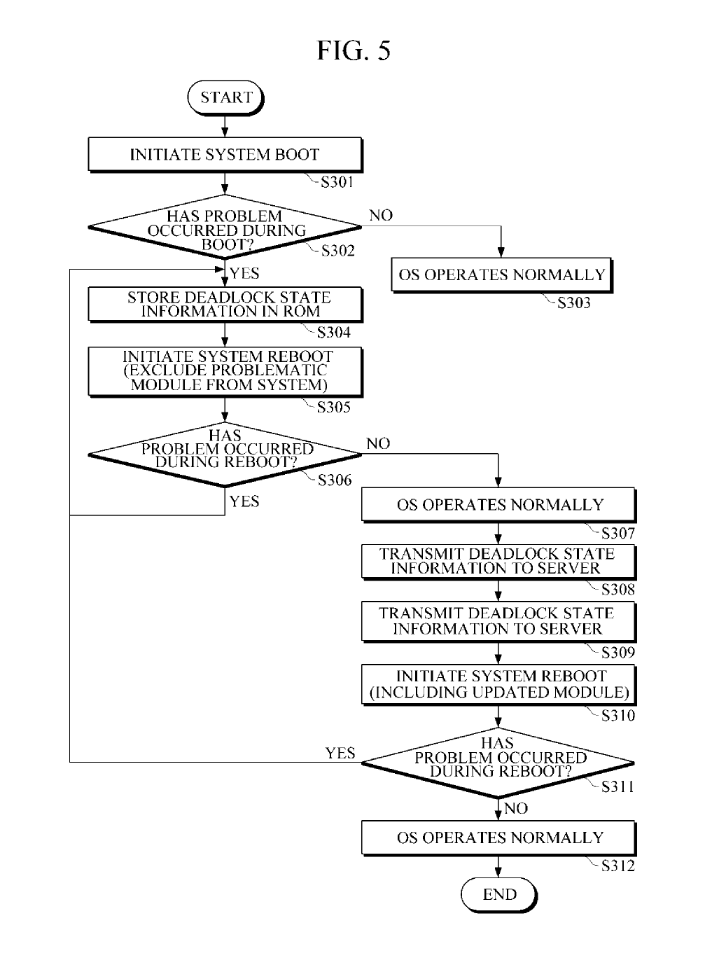

FIG. 5 is a flowchart illustrating a method for handling rebooting of a mobile terminal according to an exemplary embodiment of the present invention. Similar to FIG. 3, FIG. 5 illustrates a deadlock state resolution process in response to a determination that a mobile terminal falls into a deadlock state during a booting process. When booting a system of a mobile terminal, a device driver may be initialized abnormally and a problem may be occurred to the device driver whereby the mobile terminal enters into a deadlock state. In FIG. 5, the number of times that the problem has occurred in a device driver is not considered, however, if the count information is utilized and included, the number of times that the problem has occurred in a device driver may be considered in operations S302, S306, and/or S311. FIG. 5 includes a process of rebooting the system of the mobile terminal by resolving a problem of a problematic device driver.

Referring to FIG. 5, booting of a system of a mobile terminal is initiated in operation S301. Next, it may be determined whether a problem has occurred during the booting process in operation S302. If it is determined that a problem has not occurred during the booting process, an OS is set and operates normally as determined in operation S303 and thus, a reboot process is not performed. If it is determined that a problem has occurred during the booting process as determined in operation S303, deadlock state information may be stored in a rewrite (RW) area of ROM in operation S304. Since system booting of the mobile terminal is not performed appropriately, rebooting of the system of the mobile terminal may be performed in operation S305. When rebooting the system of the mobile terminal, the deadlock state information stored in operation S304 may also be loaded into a shared memory of RAM together with other booting information. In operation S305, rebooting is performed without initializing the problematic device driver.

Next, it may be determined whether a problem has occurred during the reboot process in operation S306. If it is determined that a problem has occurred again during the reboot process, the operation S304 and subsequent operations may be repeated. If it is determined that a problem has not occurred during the reboot process, the OS is set and operates normally in operation S307. Even if the OS is set and operates normally in operation S307, the device driver included in the deadlock state information in operation S304 may not be initialized and as a result the corresponding device driver enters into an inactive state.

The deadlock state information may be transmitted to a server or a service server of a manufacturer (manufacturer's server) in operation S308. Using a network, such as a mobile communication network or a WLAN, a user may access a server of a manufacturer and transmit the deadlock state information. At least device ID information of a problematic device driver may be included in the deadlock state information.

In response to the deadlock state information transmitted in operation S308, a corresponding module may be updated by receiving, from the server, an update file of the problematic module, e.g., the problematic device driver in response to S309. The update file may be downloaded and used to resolve the problem of the problematic device driver. For example, the update file may be a patch file for an existing driver file or a new driver file that replaces the existing driver file. The update process in operation S309 may be performed according to a general module update procedure of the mobile terminal. If a problematic module is present, only the problematic module may be excluded and the OS of the mobile terminal may be set and operate normally (operations S305, S306, and S307) so that the update process in operation S309 may be performed normally.

If the update process in operation S309 is completed, rebooting of the system of the mobile terminal may be performed in operation S310. Similar to the rebooting process in operation S305, the rebooting process in operation S310 may be performed by a reset handler. The rebooting process in operation S310 may be different from the rebooting process in operation S305. Whereas the problematic module is excluded from the system in the rebooting process in operation S305, an update is performed and the module updated in operation S309 may be initialized in the rebooting process in operation S310. If the system is rebooted in operation S310, it may be determined whether a problem has occurred during the reboot process in operation S311. If it is determined that a problem has occurred even during the reboot process, the operation S304 and subsequent operations may be repeated. If it is determined that a problem has not occurred during the reboot process, the OS is set and operates normally in operation S312.

According to the related art, if a problem occurs in the mobile terminal that causes the mobile terminal to be continuously reset, the mobile terminal may operate abnormally and the user may have no choice but to visit a service center to repair the mobile terminal. However, according to exemplary embodiments of the present invention, even if a problem occurs in the mobile terminal that causes the mobile terminal to be reset several times or fail to boot, the mobile terminal may be booted in a limited booting process by analyzing the cause and eliminating the initialization process of the problematic module. Accordingly, the user may back-up important data stored in the mobile terminal without visiting a service center. Further, by transmitting a verified problem to a manufacturer's server, and the like, the manufacturer's server may transmit an updated file to recover the problematic module.

According to exemplary embodiments of the present invention, even if a mobile terminal is reset several times or may not be rebooted due to a problem occurring in the mobile terminal, it may be possible to boot the mobile terminal by analyzing the cause of failure and avoiding it when rebooting the mobile terminal. Therefore, a user may back-up important data stored in the mobile terminal without visiting a service center. In addition, it may be possible to enable countermeasures to be performed appropriately by transmitting a verified problem to a manufacturer server and the like.

Exemplary embodiments of the present invention can be implemented as computer readable instructions in a non-transitory computer-readable recording medium. The computer-readable recording medium may include all types of recording media in which computer readable data are stored. Examples of the computer readable recording medium include a ROM, a RAM, a CD-ROM, a magnetic tape, a floppy disk, and an optical data storage. In addition, the computer readable recording medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal to handle a booting process, comprising:
a processor to process the booting process;
a log storage to store error information of a module extracted from a system log; and
a log comparator, during the booting process, to extract the error information of the module from the log storage, and to exclude an initialization of the module based on the error information of the module stored in the log storage.

2. The mobile terminal of claim 1, wherein the module comprises a device driver, and the error information of the module comprises deadlock state information of the device driver.

3. The mobile terminal of claim 1, wherein the log storage stores a log table comprising identification information of multiple modules and flags of the multiple modules, the multiple modules in the log table being sorted according to a registered order of the multiple modules.

4. The mobile terminal of claim 3, further comprising: a log analyzer to read the log table, and to modify the system log by writing the error information of the module in the system log if a flag of the module indicates that the module is in a deadlock state.

5. The mobile terminal of claim 1, further comprising: a log extractor to extract the error information of the module from the system log, and to write the error information of the module in the log storage.

6. The mobile terminal of claim 1, wherein the log storage comprises a random access memory (RAM) and/or a register to store the error information of the module.

7. The mobile terminal of claim 1, wherein the error information of the module comprises identification information of the module and count information of the module, the count information of the module indicating a number of errors occurred with respect to the module.

8. The mobile terminal of claim 7, wherein the log comparator excludes the initialization of the module if the number of errors is greater than or equal to a reference value.

9. The mobile terminal of claim 1, further comprising:
a driver observer to detect the error information of the module based on a receipt of a driver signal from the module.

10. The mobile terminal of claim 1, further comprising: a log transmitter to transmit the error information to a server.

11. A method that uses a processor to handle a booting process, comprising:
loading error information of a module from a system log to a log storage;
processing, using the processor, the booting process by initializing multiple modules; and
determining whether to initialize the module based on the loaded error information of the module.

12. The method of claim 11, wherein the module comprises a device driver, and the error information of the module comprises deadlock state information of the device driver.

13. The method of claim 10, further comprising: storing a log table comprising identification information of multiple modules and flags of the multiple modules, the multiple modules in the log table being sorted according to a registered order of the multiple modules.

14. The method of claim 13, further comprising:
reading the log table; and
modifying the system log by writing the error information of the module in the system log if a flag of the module indicates that the module is in a deadlock state.

15. The method of claim 11, further comprising:
extracting the error information of the module from the system log; and
writing the error information of the module in the log storage.

16. The method of claim 11, wherein the log storage comprises a random access memory (RAM) to store the error information of the module.

17. The method of claim 11, the error information of the module comprises identification information of the module and count information of the module, the count information of the module indicating a number of errors occurred with respect to the module.

18. The method of claim 17, further comprising: excluding the initialization of the module if the number of errors is greater than or equal to a reference value.

19. The method of claim 11, further comprising: detecting the error information of the module based on a receipt of a driver signal from the module.

20. A mobile terminal to handle a booting process, comprising:
a processor to process the booting process;
a log analyzer to read a log table comprising identification information of a module and a flag of the module, and to modify a system log by writing the identification information of the module in the system log if the flag of the module indicates that the module is in a deadlock state; and
a log storage to store the identification information of the module extracted from a system log.
